(19) United States
(12) Patent Application Publication
(10) Pub. No.: US 2010/0263331 A1
(43) Pub. Date: Oct. 21, 2010

(54) APPARATUS, A METHOD, AND A FILM FOR FILM WRAPPING

(75) Inventors: Jari Paavola, Masku (FI); Yrjo Suolahti, Masku (FI)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: OY M. HALOILA AB, Masku (FI)

(21) Appl. No.: 12/745,526

(22) PCT Filed: Jan. 26, 2009
(86) PCT No.: PCT/IB09/50315

§ 371 Date: May 28, 2010

(30) Foreign Application Priority Data
Jan. 30, 2008 (FI) 20085071

(51) Int. Cl. B65B 11/02; B65B 41/18; B44F 1/00; B65B 61/26

(52) U.S. Cl. 53/441; 428/195.1; 53/556; 53/135.3

(57) ABSTRACT

A method for wrapping a wrap film around an object includes the steps of—feeding the wrap film around the object from a wrap film roll, feeding an additional film from an additional film roll to the vicinity of the wrap film fed from the wrap film roll. The additional film and the wrap film are contacted with each other to adhere the additional film to the wrap film and to feed the adhered films around the object. The additional film adhered to the wrap film is cut at a point which is separate from the wrap film to stop feeding the additional film around the object. In particular, the method includes recognizing of a recognition mark arranged to the additional film that is fed adhered to the wrap film around the object, and cutting the additional film, at a predetermined point relative to the recognition mark.

### FIELD OF THE INVENTION

The invention relates to film wrapping apparatuses and methods particularly in cases where, in addition to the actual wrap film, a certain amount of another, additional wrapping including text or patterns is added to the wrapping.

### BACKGROUND OF THE INVENTION

Different kinds of film wrapping arrangements are known in the industry and for example in the commercial logistics systems. At the most typical, the objective of wrapping is to wrap products which have been packed on a standard-size wooden pallet in a transparent plastic film which improves the cohesion of the wrapped object and protects it to some extent from weather and soiling.

Instead of a mere transparent wrapping, a label of the manufacturer or the supplier or other text or pattern is often desired for the wrapping, either for advertising purposes or as an identifier of the wrapped product. In this case, a known solution comprises an arrangement in which another, additional film including the desired patterns or the like is made adhere to the actual uncoiling wrap film before the wrapping is provided around the object. The additional film that has been made adhere to the wrap film is conveyed around the object with the wrap film and becomes part of the wrapping of the object. When it is desirable to stop feeding the additional film around the object, it is cut before the connection point of the films.

The apparatuses as described above have been described for example in patents US6393808 and FI115395.

### SUMMARY OF THE INVENTION

The film wrapping apparatus, method and film of the invention are characterized by what has been presented in claims 1, 4 and 7, respectively.

The film wrapping apparatus of the invention for wrapping a wrap film around an object comprises
first support means for supporting a wrap film roll and second support means for supporting an additional film roll to rotate in the apparatus,
first film feeding means which form a film path for feeding the wrap film around the object from the wrap film roll,
second film feeding means for feeding additional film to the vicinity of the film path from the additional film roll,
transfer means for moving the additional film that has been fed to the vicinity of the film path and the film path to contact each other in order to adhere the additional film to the wrap film to feed the additional film adhered to the wrap film around the object, and
cutting means for cutting the additional film that has been adhered to the wrap film at a point that is separate from the wrap film to stop feeding the additional film around the object.

The film wrapping apparatus and the support means, film feeding means, transfer means and cutting means as parts thereof may conform to any known film wrapping apparatuses. Their details are not essential for the basic idea of the invention and are therefore not described in more detail herein. At the most typical, the support means are some sort of seats arranged to partly extend inside the cores of the film rolls. The film feeding means, on the other hand, typically include various rollers around which the film is conducted and which facilitate for example in providing the desired stretch to the film. The transfer means may be for example a swing bar which is arranged to move one roller of the first or the second film feeding means between two positions, so that in the first one, the roller contacts one roller of the second or the first film feeding means, respectively, and in the second one it is separate from that roller. The cutting means may include for example a metal wire that can be heated or a cutoff blade and means for moving the metal wire or the blade in order to cut the film. Examples of the known film wrapping apparatuses including said means are presented for example in patent publications US6393808 and FI115395.

According to the invention, the film wrapping apparatus comprises recognition means for recognizing a recognition mark, arranged to the additional film that is fed adhered to the wrap film around the object, at a predetermined recognition site between the additional film roll and the film path, and control means for conducting the cutting means to cut the additional film, based on the recognition of the recognition mark, as seen in the longitudinal direction of the additional film, at a predetermined point relative to the position of the recognition mark. The recognition mark may be any mark which differs from the rest of the additional film and is recognizable from outside the film, for example a graphical identifier of a specific shape.

Recognition of the recognition mark and controlled cutting of the film based on the recognition at a predetermined point relative to the position of the recognition mark provides considerable advantages compared to the known solutions. The additional film can thus be cut at a desired point which may be based for example on the length of the additional film that has been fed. On the other had, when using an additional film including, in the longitudinal direction of the film, patterns, such as company logos or the like, which are separate from each other, the recognition mark and its recognition may aid in ensuring that the film is not cut through such pattern but between the patterns. Thanks to the recognition marks, it is also possible to add to the film wrapping for example only a section of the additional film at a time comprising one pattern.

The invention is extremely universal and suitable for use in conjunction with all different types of film wrapping apparatuses. The apparatus may be arranged to wrap a stationary object in which case the wrapping means are arranged to be moved around the object, but the invention is as well suitable for an apparatus in which the object that is being wrapped up is rotated while the actual wrapping means are stationary or move only in the vertical direction.

The recognition means preferably include a light cell arrangement, comprising a light source and a light detector, for emitting a light signal to the light detector via the additional film that is fed adhered to the wrap film around the object to recognize the recognition mark based on a change provided by the recognition mark in the light signal. There is a wide range of different types of commercially available light cell apparatuses, and the light cell apparatus per se does therefore not need to be described in any more detail in this context. As described, in this embodiment of the invention the recognition mark is detected optically, but the recognition means may also comprise means detecting the recognition mark in any other remote reading technique.

In one preferred embodiment of the invention, the first film feeding means are arranged to feed the wrap film around the object at constant speed, and the cutting means are arranged to cut the additional film after a predetermined period of time from the recognition of the recognition mark. As the recognition means naturally are always positioned preferably at the same site between the additional film roll and the film path, the cutoff point is always fixed at the same specific distance from the recognition mark. This provides for example the considerable advantage that the apparatus does not need to be separately adjusted for different additional films, but it is sufficient that the recognition marks of each additional film are always arranged at a standard distance from the desired cutoff points.

The method of the invention for wrapping a wrap film around an object comprises the steps in which
wrap film is fed around an object from a wrap film roll
additional film is fed from an additional film roll to the vicinity of the wrap film that has been fed from the wrap film roll,
the additional film that has been fed to the vicinity of the wrap film and the wrap film are contacted with each other to adhere the additional film to the wrap film and to feed it adhered to the wrap film around the object, and
the additional film that has been adhered to the wrap film is cut at a point that is separate from the wrap film to stop feeding the additional film around the object.

According to the invention, the method comprises recognition of a recognition mark, arranged to the additional film that is fed adhered to the wrap film around the object, preferably at a predetermined site between the additional film roll and the wrap film, and cutting the additional film based on the recognition of the recognition mark, as seen in the longitudinal direction of the additional film, at a predetermined point relative to the recognition mark.

Recognition of the recognition mark is preferably carried out automatically as remote reading by monitoring the additional film with recognition means which are separate from it. In one preferred embodiment of the invention, a light signal is emitted via the additional film that is fed adhered to the wrap film around the object, the light signal that has propagated via the additional film is received and the recognition mark is recognized based on a change it provides in the light signal. The change in the light signal arriving to the light detector may be for example reduction of intensity provided by a non-transparent recognition mark printed on transparent additional film.

The wrap film is fed around the object preferably at constant speed and the additional film is cut after a specific period of time from the recognition of the recognition mark. As the recognition is performed always at the same site between the additional film roll and the wrap film, the distance of the cutoff point of the additional film from the recognition mark is thereby fixed. When this fixed positioning between the recognition mark and the desired cutoff point is applied to all additional films, the actual apparatus does not need to be separately adjusted for different additional films.

The film of the invention for use as the additional film in the above-described film wrapping apparatus or method comprises, as seen in the longitudinal direction of the film, patterns which are separate from each other. The patterns may be for example company logos or advertisements or, on the other hand, for example patterns needed to identify or recognize the object that is being wrapped up in the logistics chain.

According to the invention, the film comprises recognition marks, as seen in the longitudinal direction of the film, at predetermined sites relative to the patterns of the film. The recognition marks may be any marks which are preferably automatically recognizable from the moving film. A good alternative is a graphic, optically detectable mark, but the recognition may also be based on some other remote reading technique. Distance of the recognition mark from the desired cutoff point depends for example on the operational delays of the recognition and control apparatuses and on the feeding rate of the wrap film.

### BRIEF DESCRIPTION OF THE DRAWINGS

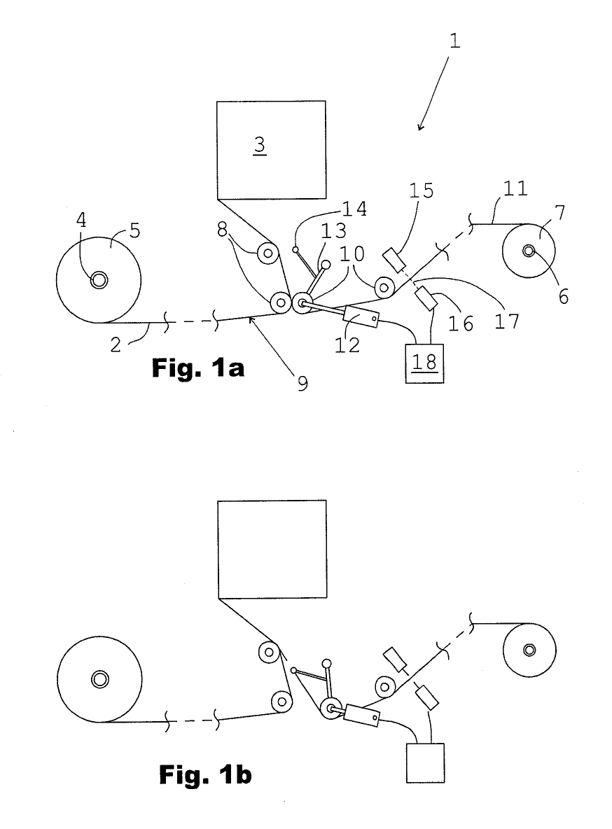

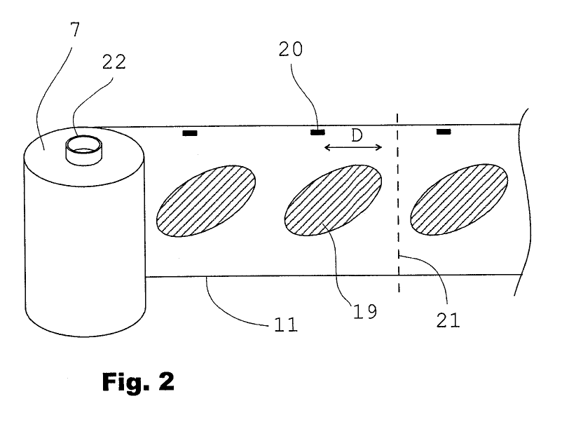

In the following section, the invention will be described with the aid of the accompanying figures in which FIGS. 1a and 1b present parts of one film wrapping apparatus according to the invention and FIG. 2 presents an example of the film according to the invention.

### DETAILED DESCRIPTION OF THE INVENTION

The film wrapping apparatus 1 of FIGS. 1a and 1b comprises seats 4 for supporting a wrap film roll 5 to rotate in the apparatus in such manner that wrap film 2 can be unwound from the wrap film roll by rotating it. To conduct the film which is unwinding from the wrap film roll around an object 3 that is being wrapped up along a desired path 9, the apparatus comprises first rollers 8 around which the wrap film is conducted. In addition to conducting the wrap film, the rollers may be used to arrange a desired tension or stretch to the film. The apparatus also comprises second seats 6 for supporting an additional film roll 7 to rotate as well in the apparatus and second rollers 10 for conducting additional film 11 which is unwinding from the additional film roll 7 to the vicinity of the wrap film path from the additional film roll. The apparatus may naturally also comprise drawing devices (not shown in the figure) as the film feeding means for drawing the wrap film and the additional film from their rolls via rollers 8, 10 to the film path and to the vicinity of the film path, respectively. The last one of the second rollers in the feeding direction of the additional film is connected to a swing bar 13 pivoted at one end to the apparatus and arranged to be moved by means of a cylinder 12 between two positions. In one position, said roller is spaced at a distance from the wrap film path 9. In the other position, said roller is moved to contact one of the first rollers. The last roller preferably comprises means for holding, the end of the additional film against the roller for example by vacuum suction. There is also a film cutter 14 connected via a supporting arm to the swing bar 13, extending in the lateral direction of the wrap film that is moving along the film path 9 and comprising a wire that can be heated. The film cutter could alternatively also comprise a cutoff blade or some other cutting means.

The seats, rollers and other optional film feeding means may be arranged to move around the object that is being wrapped up for example as in the apparatus of publication FI115395. On the other hand, the apparatus may comprise means for rotating the object 3 that is being wrapped up while the rest of the apparatus remains stationary. The apparatus typically also comprises means for moving the film feeding means and the object that is being wrapped up relative to each other in the vertical direction to extend the wrapping to the total height of the object.

The apparatus includes a light cell comprising a light source 15 and a light detector 16. The light source 15 is arranged to emit a light signal 17 to the light detector 16 through the additional film 11 that is fed from the additional film roll 7. Naturally, it would be possible that the light source and the light detector were on the same side of the additional film in which case a signal reflected from the additional film would be provided to the receiver. The light detector is connected to a control device which, for its part, is arranged to conduct the cylinder 12.

The operation of the apparatus will now be described briefly. FIG. 1a presents a situation where the wrap film 2 is fed around the object 3 from the wrap film roll 5. Additional film 11 has been fed from the additional film roll 7 to the vicinity of the wrap film path 9 via a passage defined by the second rollers, after which the last one of the second rollers 10 has been moved by the cylinder 12 to contact one of the first rollers 8 in order to adhere the additional film to the wrap film 2 between the rollers. The additional film which has been adhered in this manner to the wrap film is conducted around the object 3 with the actual wrap film.

The additional film that runs from the additional film roll is monitored by the light source 15 and the light detector 16 by observing the signal that arrives to the light detector by an electrical control device 18. When a change provided by the recognition mark of the additional film is detected in the signal, the cylinder 12 is conducted by the control device to move the last roller of the second rollers 10 apart from the film path 9 after a predetermined period of time, whereby the additional film becomes detached from the wrap film at that roller and for a specific distance after the roller. At the same time, the film cutter which is connected to the swing bar 13 moves so as to cut the additional film after the last of the second rollers 10 at a point which is separate from the wrap film, as presented in FIG. 1b. In this manner, feeding of the additional film around the object stops.

The additional film 11 of FIG. 2 which is made from transparent plastic material comprises successive patterns 19 in the longitudinal direction of the film. The patterns may be for example logos of the manufacturer of the products which are contained by the object that is being wrapped up, or the like. However, in some embodiments, the patterns may also include information required for the subsequent identification of the object that is being wrapped up. In addition, there are non-transparent rectangular recognition marks 20 by the edge of the additional film. Each of the recognition marks 20 is positioned at a fixed distance D from the edge of the nearest pattern 19 in the longitudinal direction of the film. In this manner, when the additional film is applied in the apparatus according to FIGS. 1a and 1b, the cutoff point 21 of the additional film will always be provided at the same position relative to the pattern. In the apparatus described above, cutting may be conducted so as to take place for example after a specific number of detected recognition marks. On the other hand, it would be possible that the additional film had recognition marks only in the vicinity of the desired cutoff points and not one per each pattern as is the case in the film of FIG. 2. The additional film has been coiled to provide the roll 7 around the core 22. The roll may be supported by the ends of the core to rotate by the seats 6 of the film wrapping apparatus.

It should be noted that the invention is not limited to the examples referred to above; instead, its embodiments may vary freely within the scope of the claims. For example, contacting the additional film and the wrap film with each other may also be arranged to take place by moving the wrap film or both of the films, although, in the example presented above, this is performed by moving only the additional film.

1. A film wrapping apparatus for wrapping a wrap film around an object, comprising
first support means for supporting a wrap film roll and second support means for supporting an additional film roll to rotate in the apparatus,
first film feeding means which form a film path for feeding the wrap film around the object from the wrap film roll,
second film feeding means for feeding additional film from the additional film roll to the vicinity of the film path,
transfer means for moving the additional film that has been fed to the vicinity of the film path and the film path to contact each other in order to adhere the additional film to the wrap film that is fed around the object so as to feed the additional film adhered to the wrap film around the object, and
cutting means for cutting the additional film that has been adhered to the wrap film at a point that is separate from the wrap film to stop feeding the additional film around the object,
characterized in that the film wrapping apparatus comprises recognition means for recognizing a recognition mark arranged to the additional film that is fed adhered to the wrap film around the object, and control means for conducting the cutting means so as to cut the additional film, based on the recognition, at a predetermined point relative to the position of the recognition mark.

2. The film wrapping apparatus according to claim 1, characterized in that the recognition means include a light cell arrangement, comprising a light source and a light detector, for emitting a light signal from the light source to the light detector via the additional film that is fed adhered to the wrap film
around the object in order to recognize the recognition mark based on a change provided by the recognition mark in the light signal.

3. The film wrapping apparatus according to claim 1, characterized in that the first film feeding means are arranged to feed the wrap film around the object at constant speed, and that the cutting means are arranged to cut the additional film after a predetermined period of time from the recognition of the recognition mark.

4. A method for wrapping a wrap film around an object, comprising the steps in which
wrap film is fed around the object from a wrap film roll,
additional film is fed from an additional film roll to the vicinity of the wrap film that has been fed from the wrap film roll,
the additional film that has been fed to the vicinity of the wrap film and the wrap film are contacted with each other in order to adhere the additional film to the wrap film and to feed it adhered to the wrap film around the object, and
the additional film that has been adhered to the wrap film is cut at a point that is separate from the wrap film to stop feeding the additional film around the object,
characterized in that a recognition mark arranged to the additional film that is fed adhered to the wrap film around the object is recognized, and the additional film is cut, based on the recognition, at a predetermined point relative to the recognition mark.

5. The method according to claim 4, characterized in that a light signal is emitted via the additional film that is fed adhered to the wrap film around the object, the light signal that has traveled via the additional film is received, and the recognition mark is recognized based on a change it provides in the light signal.

6. The method according to claim 4, characterized in that the wrap film is fed around the object at constant speed, and the additional film is cut after a specific period of time from the recognition of the recognition mark.

7. A film for use as an additional film in the film wrapping apparatus according to claim 1, the film comprising patterns that are separate from each other as seen in the longitudinal direction of the film, characterized in that the film comprises recognition marks, as seen in the longitudinal direction of the film, at predetermined sites relative to the patterns of the film.
